(19) United States
(12) Patent Application Publication
(10) Pub. No.: US 2004/0129298 A1
(43) Pub. Date: Jul. 8, 2004

(54) Deinking, cleaning and maintenance method for printing presses and device therefor

(76) Inventors: Jean Lucien Sarda, Paris (FR); Jean-Claude Sarda, Paris (FR)

Correspondence Address: PEACOCK MYERS AND ADAMS P C, P O BOX 26927, ALBUQUERQUE, NM, 871256927

(21) Appl. No.: 10/450,670

(22) PCT Filed: Dec. 5, 2001
(86) PCT No.: PCT/EP01/14710

(30) Foreign Application Priority Data
Dec. 14, 2000 (FR) 0016279

(51) Int. Cl. B08B 1/02

(52) U.S. Cl. 134/32

(57) ABSTRACT

The present invention is related to a procedure and a mechanism mainly made to achieve all of the de-inking, cleaning and maintenance functions for the various parts of printing presses of all types, printing paper sheet by paper sheet or continuously. It also concerns in particular all their inking, soaking, offset printing plaques, printing cylinder blankets, counter-pressure cylinders, inkers, etc. and the cleaning of all printing materials including de-inking, cleaning and maintenance requires a constant elimination of residues such as inks, glazes through either a scraping action or through their successive dispersals in a solvent environment.

### CROSS-REFERENCE TO RELATED APPLICATIONS

Not Applicable.

### STATEMENT REGARDING FEDERALLY SPONSORED RESEARCH OR DEVELOPMENT

### BACKGROUND OF THE INVENTION

Not Applicable.

### FIELD OF THE INVENTION (TECHNICAL FIELD)

The present invention is related to a procedure and a mechanism mainly made to achieve all of the de-inking, cleaning and maintenance functions for the various parts of printing presses of all types, printing paper sheet by paper sheet or continuously. It also concerns in particular all their inking, soaking, offset printing plaques, printing cylinder blankets, counter-pressure cylinders, inkers, etc. and the cleaning of all printing materials including de-inking, cleaning and maintenance requires a constant elimination of residues such as inks, glazes through either a scraping action or through their successive dispersals in a solvent environment.

At the present time, printing presses of all types: offset, typographic and others, are equipped with de-inking devices from their inking group that work almost entirely by scraping ink residues that were previously strongly dissolved. However, their offset printing plaques as well as their cylinder blankets, counter-pressure cylinders and inkwells are manually cleaned up with sponges and cloths except for certain presses that are in general of high volume production and are equipped with automatic washers made for cylinder blankets and counter-pressure cylinders. These washers, depending on the model, use for the extraction of ink residues tools that work by scraping as well or more rarely by successive dispersals of residues in a solvent environment.

The soaking groups, depending on their types, are cleaned up manually or automatically simultaneously with the printing inking groups. These various modes of de-inking and cleaning use, in big part, for their functioning, light and volatile solvents such as for instance light essences of hydrocarbons, chlorinated hydrocarbon, aromatic hydrocarbon, kerosene, mixed solvents made of mixtures of esters and aromatic hydrocarbon and others, in addition to solvents glycol of ether solvents, derived from ethylene as well as ketones, acetones, cyclohexane or alcohol products such as iso-propane methanol, etc.

All light solvents presently used emit Volatile Organic Compounds (VOC) at much higher rates than the ones approved by the International Directives and Norms for substances and preparations. As an example, the European Directives for the VOC approved rates for these substances or preparations are equal to zero zero one kilogram Pascal at a temperature of twenty degrees centigrade. Furthermore, based on the 67/548 EEC Directives, in general all these substances and preparations with a higher VOC rate are classified as carcinogenic, mutational or toxic for reproduction and should be replaced, if possible, with less dangerous substances or preparations. These same international bodies equally deal with the viscosity of these substances and preparations, their flash point, their general toxicity, their eco-toxicity, their label, their certificate, as well as the development of means aiming at a substantial reduction of these substances or preparations. With the objective of limiting these VOC that are considered harmful to both the human kind and the environment, these directives become, in the course of the years, more and more stern and all related sectors should comply to them. Furthermore, these solvents, by virtue of their high rate of inflammability, require highly limiting cautions in the way they are treated, shipped and used.

### BRIEF SUMMARY OF THE INVENTION

Being aware of these problems and in order to comply with such Directives, some producers of these de-inking solvents offer in substitution oily diluents or solvents that are generally of vegetal origin and more often come as light oils that contain emulsifying agents that allow them to get mixed, when used, with up to fifty percent of water, in such a way that thanks to this strong addition of water they collate to emulsion. Such an emulsion is made of the mixture of residues of ink, oil and water, and has a much lesser oily state compared to the one resulting from the mixture of ink and oil. The scraping of this last type of mixture would be completely impossible with the traditional soft scrapers working by lamination and brings to such emulsion, by virtue of this additional water, a volatile agent which function is indispensable for the functioning mode by scraping of residues, made with this type of scraper. Although these oily diluents offer great advantages compared to de-inking volatile solvents, they were not able to replace them because as presently used they cause major known inconveniences in their usage, mainly due to the fact that they use the same scraping and distribution tools as the ones used for de-inking light solvents. Such tools are totally unsuitable for the usage of these oily products.

All these de-inking solvents, except for miscible water products, are extremely fluid and volatile and have a zero internal cohesion of any kind, which is considered a negative factor for the obtaining a good de-inking.

### BRIEF DESCRIPTION OF THE SEVERAL VIEWS OF THE DRAWINGS

Other peculiar characteristics, objectives and benefits for this invention are elaborated in the following description that refers to the attached drawings and illustrates the following:

FIG. 1, a general elevation view of a conventional printing press.

FIG. 2, a perspective view of a cleaning by scraping device.

FIGS. 3-5, cross-sectional views of the variants of the implementation of this device.

FIG. 6, a three quarter view of a scraping grinder that is incorporated to the cleaning device.

FIGS. 7-8, a view from the top that illustrates particular disposable casing, that cover hard or semi-hard scrapers.

FIGS. 9 and 10, a cross-sectional and front view of an automatic distribution ramp of de-inking agents or de-inking, cleaning and maintenance products.

FIG. 11, a general perspective view of a mobile support.

### DETAILED DESCRIPTION OF THE INVENTION

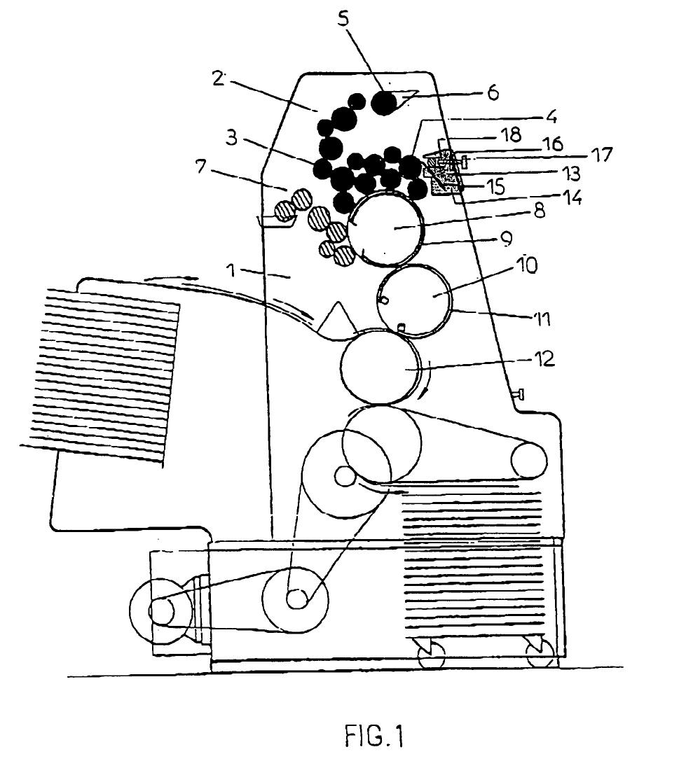

FIG. 1 is an illustration of a conventional printing press 1. It contains an inking group 2 that contains inking rolls 3, ink tables 4, an inkwell ducting cylinder 5 and its inkwell 6, a soaking group 7, a cylinder that carries the printing plaque 8, over which is placed in tension the offset printing plaque 9, a cylinder blanket carrier 10 over which is placed the printing blanket 11, a counter-pressure cylinder 12 and a de-inking device 13 of the inking group 2 that in most cases performs by scraping action of the residues with the soft scraper 15. All the elements of the group of inking 2, soaking 7, offset printing plaque 9, printing blanket 11 and counter-pressure cylinder 12 must be in function and continuously kept clean in order to allow a normal usage of the press.

Depending on the type of printing presses the inking group 2 contains an average of close to twenty inking rolls 3 in addition to ink tables 4. The inking rolls are made of rubber and dragged into rotation through friction by the ink tables and in addition to their positive rotation movement, they perform a movement of axial backward and forward displacement aimed at grinding the ink. All of these elements are slightly pressed to each other and exercise the function of guiding and homogenizing an ink film that is extracted from the inkwell 6 to ink the offset printing plaque 9 at each printing cycle. The printing presses 1 that are equipped with these inking groups 2 use oily and viscous printing inks. They require de-inking at each change in color or in type of ink or at every time these inks become, by virtue of excessive siccativity or pollution, inappropriate for printing.

In order to avoid any leaking of the highly liquid residues from the edges of the de-inking device's tray 13, two stable lateral inner walls close their ends. The de-inking device 13 is attached to the printing press through milled buttons 17 placed on the fixing legs 16. The milled buttons 17 are screwed on the threaded linking contacts 18, permanently placed for this usage over the printing press 1.

At each de-inking operation, the de-inking device 13 of the inking group is brought from its storing location and linked, in a functioning position, to the printing press 1. Before the soft scraper is applied in an almost tangential fashion to the ink table 4, through the action of the milled buttons 17, the weak solvent of the to-be-extracted residues is largely distributed to all the rubber inking rolls 3 and to the ink tables 4. The purpose of this action is to strongly disperse and oil off the residues because through this scraping principle that uses soft scrapers which tender edge of scraping and recovering of residues bends and quickly connects to the round shape of the ink tables 4, the scraping takes place “by lamination”, at a low pressure and consequently does not allow scraping and extracting of all residues, agents and products that are oily, lubricant, sticky, glued or consistent, without leaving at the end of the de-inking operation, a thick film of residues over either the scraped ink table 4 or the set of rubber inking rolls and ink tables 4 of the inking group, consequently making it impossible any following inking and thus requiring a beforehand neutralization, by dispersing them with weak solvents, the oily, viscous and consistent state of the ink residues and to make them sufficiently fluid so that they would leak practically by themselves over the soft scrapers 15. The term scraping, usually used for this kind of function is considered in this case of usage, relatively inappropriate, by virtue of the fact that the scraping action means indirectly that the active part of the scraper exerts a mechanical action, able to break, detach and recuperate, in either its state or with a slight dilution, the residual film. In the course of scraping and at many instances a certain quantity of de-inking solvent must be distributed to move and recuperate the residues. At the end of the de-inking operation, the residual film over the surface of the rolls is highly loaded in solvent that does not have, by virtue of a lack of internal cohesion and volatility, the possibility to coat and transfer in an appropriate manner the fine residual micro-particles. These solvents disappear through evaporation in the atmosphere, leaving these latter micro-particles of ink strongly fixed on the surface and trapped inside the porosity of 5 the rubber. In the beginning of the de-inking operation, the dissolved quantity of ink leaks and accumulates on the soft scraper 15, with an angle close to thirty degrees and part of the active scraping located on top of the axis of the ink table 1 with which it cooperates. As the operator re-distributes large amounts of de-inking 10 solvents the ink residues become more and more liquid, leaking and soiling all the surface of the soft scraper 15 and the recovering tray 14 of the residues that are usually in different plans.

At the end of the de-inking operation, and in order to attempt to extract a maximum amount of residues, a considerable amount of solvent is distributed and collected by the scraper that is practically in a pure state. This amount is mixed to the fluid residues and piles up, at the liquid state, in the bottom of the recovery tray 14 that becomes totally polluted, difficult to be moved and cleaned up without the risk of spattering these liquid residues. This de-inking 20 device 13 is then removed from the printing press to be basically taken to its location of cleaning and storing, yet more often to be used several times before cleaning it, the printer, for lack of time and in order to avoid a constraining, long and fastidious cleaning of the de-inking device, sets it dirty at the foot of the printing press, from 25 which the solvents start evaporating through the atmosphere. During the cleaning process of the recovery tray 14 from residues, the volatile solvents used for this function sharpen the emission of VOC developed during their scraping and storing away from the air. These residues are more often eliminated with no particular precaution or stored away from the air so that they would be treated later.

On the other hand, the usage of these solvents requires, all along this function, a strong monitoring from the part of the operator, because a lack of distribution of light solvent, that evaporates quickly, instantaneously destroys the soft scraper 15 by abrasion on the ink table 4 with which it cooperates.

In order to avoid such a defect, some producers have suggested, over very few printing presses, to replace these rubber scrapers with plastic scrapers, like polyamide, of which active parts of scraping also work “by lamination”, like in the case of soft scrapers 15, in order to preserve the same easiness of interchangeability of these soft scrapers and which allow them, through their active part that works “by lamination”, to be able to cooperate, in a quasi universal fashion, with any kind of ink table of which surface is generally coated with a film made of plastic like “rilsan”, have, beside these oiling properties, a good coefficient of friction yet a very weak mechanical resistance, often causing, with time, scratches over the surface preventing these tables, without any previous checking and eventually reset in order, to be mechanically scraped with tough materials that contain a sharp scraping edge that could also be part of these scratches and instantaneously destroy the “rilsan” film.

This type of scrapers made of tough plastic material, which works “by lamination” has practically disappeared from the market because it does not bring any general performance significant improvement with respect to the soft scrapers 15. The high simplicity of interchangeability unquestionably brought by the usage of scrapers that work “by lamination”, allowing the usage of all kinds of ink tables 4 regardless of the nature of their surfaces, is unquestionable and represents, through its universality of usage, a great commercial easiness for their distributors, and thus almost all printing presses presently in service in addition to the ones sold all over the world are equipped with this type of scraper. This advantage brought by these scrapers, is however of practically minor benefit by virtue of serious technical inadequacies and nuisances resulting from their usage.

This principle of de-inking of printing presses, as it is carried out at the present time, with scrapers working “by lamination”, requiring the usage of light volatile solvents, corresponds in fact to a general superficial de-inking swiftly entailing, over the rubber surfaces, an “glazing” that mainly takes shape through accumulation and fixing of residual micro particles on the surface and inside their porosities. Such a phenomenon is known for quickly removing from these rubber surfaces their best properties of homogenization, of transfer 5 and carrying of the ink film, causing a large amount of waste of the printing definition, which is considered a very negative factor for the printer, who is concerned about optimizing the quality of his printing material; such a handicap is difficult to overcome given that every new de-inking operation, in general six to ten per day, contributes to the accentuation of such a defect. On the other hand and except for few rare modern printing presses, equipped with automatic distribution means, solvents are manually distributed in a randomly fashion, thus generating a useless and costly profusion of harmful solvents to which is added the solvent resulting from a ba______ 15 mechanical performance of used scrapers. This operating way leads to a certain amount of major insufficiencies of which the main ones could be defined in a comprehensive manner as such:—The need to use light solvents offering, beside products that are necessarily strongly emulsified with water to make them usable with scrapers 20 working “by lamination”, high rates of VOC emission, a strong flammability and a low rate of biodegradability in addition to a set of general known noxiousness and nuisance,—Consumption of de-inking solvents that is very high and totally disproportioned with the mediocre quality of the obtained results,—The need to have to render 25 soluble and fluid in an excessive and random manner the consistent, viscous and sticky residues in order to allow to the scrapers working “by lamination“to collect them, entailing, among other inconveniences a parasitic out flowing of liquid residues at each end of the ink rolls and tables making the de-inking device, following 30 any usage difficult to move and clean without risking splashes of liquid residues particularly stubborn and messy, making this de-inking operation a real servitude for the printer during the printing cycle.

Lack of a real permanent cleaning and maintenance action for the treated surfaces,

In most cases, lack of tools that allow a dosed and controlled distribution of cleaning solvents thus highly increasing their consumption that is already

excessive, contributing to accentuating the irrational side of this function,

Impossibility to fully automate the de-inking function without making use, for the evacuation of residues and rinsing of polluted surfaces, of a significant and costly amount of de-inking solvents to totally liquefy, thus making this function unacceptable for almost all printing workshops that do not have access to means necessary for the recycling of these solvents.

The main disadvantages of devices such as the ones described above have lead the Inquirers to imagine and implement a new procedure and device for de-inking, cleaning and maintenance of printing presses.

With such a goal in mind, the invention allows to globally preserve the same methods of functioning that are usually used for the de-inking function yet its goal, under its various shapes, is to treat the large quantities of the known systems.

In its main form where ink residues are extracted by scraping, the targeted objectives are of different nature and based on the use of a set of tools mixed together or working separately, depending on the different cases to be treated. In this form the main targeted objectives for this invention are to utilize de-inking liquid agents that come for instance in the form of solvents or diluents, oily or lubricant, or de-inking, cleaning and maintenance products that are “gelled” from a liquid to a solid state, of all types, removing from the residues of oily ink any excess of stickiness or siccativity and thus causing a low rate of emission or even no emission whatsoever of Volatile Organic Components VOC, in addition to good properties of biodegradability and generally a low harm for both human organism and environment, all of this with reducing or suppressing all kinds of risks such as inflammability, explosion, etc. in addition to the total of nuisances linked to the usage of the present de-inking solvents, in a way to respect and follow the various evolving international racomm and regulations that govern, by segment of activities, the set of retained criteria to allow the decrease and suppression of the various risks and nuisances connected to such activities, among other things, to these types of products. Beside the fact that they do not emit VOC, these de-inking liquid agents have also the characteristics of being used while mixed with the tools of the procedure, despite their oily and non volatile state, without any additive such as water, and the de-inking, cleaning and maintenance products that are “gelled” from solid to liquid, like for instance a “gel” or detergent milk, are different and possess more advantages than simple de-inking agents, bringing mainly a dilution function and moving residues, by their more or less liquid consistency and by the fact that they contain, in addition to dilution agents, detergent agents that strongly enhance the movement of residues, all of this with avoiding any redeposit, thus bringing a additional function of permanent cleaning and maintenance of the rubber surfaces of the printing rolls, in a way to enhance the quality of printing and increase their longevity.

There are other significant targeted objectives in the invention such as:

Eliminating the present usage of volatile de-inking solvents which 20 cause strong emissions of Volatile Organic Components VOC, in addition to strongly reducing, in a controlled and repetitive manner, the consumption of liquid de-inking agents or de-inking, cleaning and maintenance products that are “gelled” from a liquid to a solid state thus substituting these solvents.

Using rational means of distribution of de-inking liquid agents and “gelled” de-inking, cleaning and maintenance products allowing them to dose and measure, when they are made of several components, to distribute them in right proportions of ones with respect to others and in a sequential manner that is previously established in function of the selected cleaning cycle,

Using the residues as thickening substances of the de-inking liquid agents by distributing these agents in small dosed quantities during the course of the cleaning operation and noticeably proportional with the decreasing amount of residues to be extracted, thus bringing a strong reduction in their consumption and allowing at the same time, through liquid agents, the residues to preserve enough consistency and thus avoid any parasitic out flow from the edges of the rubbery ink table and rolls, while limiting any infiltration and fixing of their micro-particles inside the pores of these rubbery surfaces,

bringing a cost efficient complete or partial automation of the cleaning function,

bringing an additional automatic cleaning function of the entire printing group by simultaneously carrying out, through the cleaning device of the de-inking group, the cleaning of the various elements of the printing group namely, the soaking group, the offset printing plaque, the printing and counter-pressure cylinder,

being able upon request, with the objective of saving time, to simplify and rationalize the cleaning function of the cleaning devices following usage, to cover, prior to usage, the active surfaces of these cleaning devices, with a disposable casing made for instance of simple sheet of paper, inexpensive, that could be set and removed with a simple motion, in order to eliminate the cleaning of the cleaning device itself and to reduce any storage of residues.

The invention also allows:

the elimination of the necessity to greatly make fluid the residues during the general de-inking operation in order to keep a relatively low rate of out flowing, so that they could be recovered in a semi-fluid state yet allowing these residues to slowly out flow during the scraping operation,

the modification the state of the oily printing ink residues, either glazed or other, by eliminating their present excess of stickiness and siccativity, in order to allow these consistent residues to easily come out from the active, smooth and disengaged parts of the cleaning devices, in a way that allows, after a certain number of de-inking, their easy evacuation all along the process, without bringing any additional solvents or diluents,

the elimination, through the consistency of residues, the major risks of soiling and splashing which usually occur during shipping and cleaning of de-inking devices containing highly liquid residues,

the significant reduction and rationalization of all th functions of de-inking and cleaning by eliminating its present empirical side, in order to allow the printer, while significantly reducing the cost of such function, to incorporate it in a repetitive way at a cost efficient price for the printed material,

the obtaining of a partial de-inking for instance of an inking group of an offset printing press or other, in order to recover the ink, by directly scraping it at “cutting”, without any previous dilution, within a limit of close to eighty per cent of the quantity of ink, depending on the scraping capability of the type of the used scraper in addition to the thickness of the ink film to be extracted, below which threshold the remaining viscous thin film no longer possess the capability to move by itself, from one roll to another and to be scraped without bringing a dilution product to move it,

The permanent maintain in its best shape of functioning of the sharp angle edge of the tough or semi-tough scrapers that are in the cleaning devices,

The improvement, in the case of absolute necessity, of the usage of the usual soft scrapers with the help of “gelled” de-inking, cleaning and maintenance products or detergent milks, that are adopted for such usage allowing the elimination of part of the present insufficiencies,

The significant enlargement of the range of the basic products used as de-inking liquid agents or used to formulate the de-inking, cleaning and maintenance “gelled” products, the price reduction and the increase of the sources of supply given that they are used along with some cleaning devices associated with a dosed mode of distribution,

The preservation and utilization, depending on the state of their surfaces, of the original ink tables of the presses to be printed, to make them function along with the cleaning devices of this procedure, equipped with scrapers that are adapted to the state in which these tables are,

The full or partial replacement of the existing means of de-inking with the new tools of de-inking, cleaning and maintenance that will result from the invention, on all types of printing presses in service, paper sheet over paper sheet or continuous, while avoiding to a maximum extent performing any type of mechanical modifications to these printing presses or directly incorporate the tools of the invention to the production of printing presses,

The elimination of the burden of long and fastidious cleaning of the present de-inking devices, of which parts that collect residues are located at several levels and are inaccessible from the edges, are filled with liquid residues that are extremely stubborn and difficult to remove, by replacing these de-inking devices with cleaning devices equipped with a set of tools that allow them to scrape and collect residues with low rate of out flow, of which excess of stickiness is eliminated, in order to easily extract them, without any additional diluent, from the cleaning device which parts that collect the residues are perfectly accessible, flat and smooth and are located on a one single plan,

The usage, within the spirit of rationalization and cost reduction of the cleaning process, mobile support allowing the execution of all functions related to these cleaning operations by connecting them to a set of printing presses.

And finally, allowing, by virtue of the capability to use de-inking liquid agents in addition to de-inking, cleaning and maintenance “gelled” products that are more or less oily, lubricant and consistent from liquid to solid, in a well assessed manner and along with cleaning devices able to directly scrape products that are as viscous, oily and consistent as an oily printing ink, to radically change the principle of functioning of the present de-inking devices, by eliminating their main negative factors which are to have to, in order to function, require harmful phenomena of volatility by virtue of the fact that the soft used scrapers are unable to scrape oily and consistent products, thus in order to collect them it is necessary to abnormally remove from oily ink residues any oily substance and make them fluid, in order to disperse with the help of thin solvents.

Therefore, the main purpose of the invention is a de-inking, cleaning and maintenance of the printing presses procedure. This principle consists of directly scraping one or several ink tables or inking rolls that are parts of the printing press inking group. This will take place with or without a very light previous dilution of the residues with the help of either liquid de-inking agents or de-inking, cleaning and maintenance products that are “gelled” from a liquid to a solid state. Scraping is made with at least hard or semi-hard scrapers that work “by cutting”, that consists of distributing the aforesaid products or agents all along the scraping operation in accordance with a light dosed flow, highly proportional with the decreasing quantity of residues to be extracted and with the scraping capacity of the hard or semi-hard scraper, that is used in such a manner to first eliminate the slipping of the rolls among each other and second to allow, through this distribution mode that is associated with the mechanical scraping action used, the significant reduction of consumption of de-inking agents and “gelled” de-inking, cleaning and maintenance products while using the residues as a thickening substance for these liquid de-inking agents or for the “gelled” de-inking, cleaning and maintenance products that are in the liquid state. The purpose is to preserve in all cases and during the entire de-inking operation sufficient consistency and homogeneity for the residues. The main purpose of the invention is to also set a cleaning device for the implementation of the aforesaid process according to which the liquid de-inking agents are either diluents or oily solvents or lubricants for the oily printing inks or either “gelled” or “gullible” de-inking, cleaning and maintenance products in the course of the cleaning operation which come from a liquid state, no or little volatile, bringing to the ink residues a low rate of out flow and favorably possessing an internal consistency that is naturally acquired, resulting from a chemical reaction or provoked by adding gelling, thixotropant, thickening etc. used either separately or together. The other components of these “gelled” de-inking, cleaning and maintenance products contain in addition to their basic diluents, detergent agents such as soaps, emulsioning, emulsifying, dispersing, soaking agents, etc . . . agents that bring them a cleaning function through chemical reaction and mechanical action, avoiding any redeposit of residual micro-particles. All the components of these different de-inking liquid agents and “gelled” de-inking, cleaning and maintenance products are chosen by virtue of the fact that they offer, given their costs and their supply possibilities, strong biodegradability properties and a zero rate of emission of volatile organic components.

Upon another characteristic of this invention, the hard scrapers of the cleaning device have a scraping edge that is tough, stiff and flexible with a sharp angle and their active scraping parts are made of materials such as metal that allow a mechanical scraping, depending on the importance of inking, directly, without any previous dilution, close to eighty percent of the reusable ink or of oily ink residues. The same active scraping parts could also be made of any type of tough materials such as plastic materials, i.e. polyurethane, polyester, polycarbonate, polypropylene, vynil polychloride, polyacetate and many others, and allowing, like in the case of hard metallic scrapers, to obtain a scraping edge that is hard, stiff and flexible, with a sharp angle that also scrapes “by cutting”. Yet its mechanical output lessens more rapidly with time compared to the one that results from a metallic scraper.

Upon another characteristic of this invention, the semi-hard scrapers of the device that perform cleaning through scraping offer a strong holding and a general mechanical rigidity and their active part is made with very slightly bendable materials, kind of elastomer of all types such as polyurethane, polyester and others. The toughness of these materials are in the order of seventy to eighty D shores; in addition they have a scraping edge that is stiff, with a slight elastic deformation and its sharp angle varies approximately from forty five to ninety degrees, depending on the toughness of these scrapers, their positioning and their angle vary according to the available positioning on the various printing presses to be equipped and that in function of this angle and their toughness, these scrapers are made rigid up to three millimeters from their sharp angled scraping edge with a metallic frame, a molding of various materials with different toughness.

The entire cleaning device is equipped with hard and semi-hard scrapers that have a smooth surface from both their scraping edge and their active face of residues recovering that are as much as possible on a single and same plan with no excrescence whatsoever. In addition, at least one of the three sides is freed in order to allow, following usage, an easy scraping with a spatula and thus facilitate the cleaning process.

In accordance with another characteristic of the invention, beside the usage of usual and costly tools, and with the objective of generalizing the automation and rationalization of the cleaning function, the distribution of the various de-inking liquid agents or “gelled” de-inking, cleaning and maintenance products is favorably granted through automatic distributor feeders that are well adapted for the execution of these various functions. They are less costly and allow a more regular distribution of these agents and products. This distribution is very low and its precise and variable flow is pre-established in function of the importance of the surfaces to be treated. Usual dosing bottles with manual control of which variable flows are adapted to the functioning mode of this process, also allow its implementation.

The dosed or measured distribution of the liquid de-inking agents and of the “gelled” de-inking, cleaning and maintenance products, at a liquid state, in addition to a well proportioned distribution of their various components of the ones with respect to the others, when these products are made of various components, represent determining factors that grant efficient functions. These factors, presently neglected in the case of using oily products as de-inking agents such as light oils alternatively distributed with water so that scraping could be made with soft scrapers, represent one of the reasons for the failure of the usage of these products, given that alternative distribution of these oils and waters, in a disproportionate and random quantities, without taking in consideration the remaining residual quantities that need to be treated, entails a negative result and serious difficulties of usage. It is important to know that the water added at a certain undetermined time during the de-inking cycle where the proportion of oil is insufficient with respect to water, resins, pigments and others constituents of oily printing inks freezes and sticks instantaneously over the oily surfaces in a hardly reversible fashion. Another negative factor is added to the main one and results in the impossibility, by the usual scrapers used, to break and scrap an oily film such as oil, without leaving a largely thick oily layer on the rolls and ink tables. Such a factor does not allow neither a sufficient de-inking nor an appropriate inking, thus removing any possibility of continuing the printing process, even when re-inking with the same color. Therefore, it becomes necessary to alternate the distribution of these oils with additives such as water.

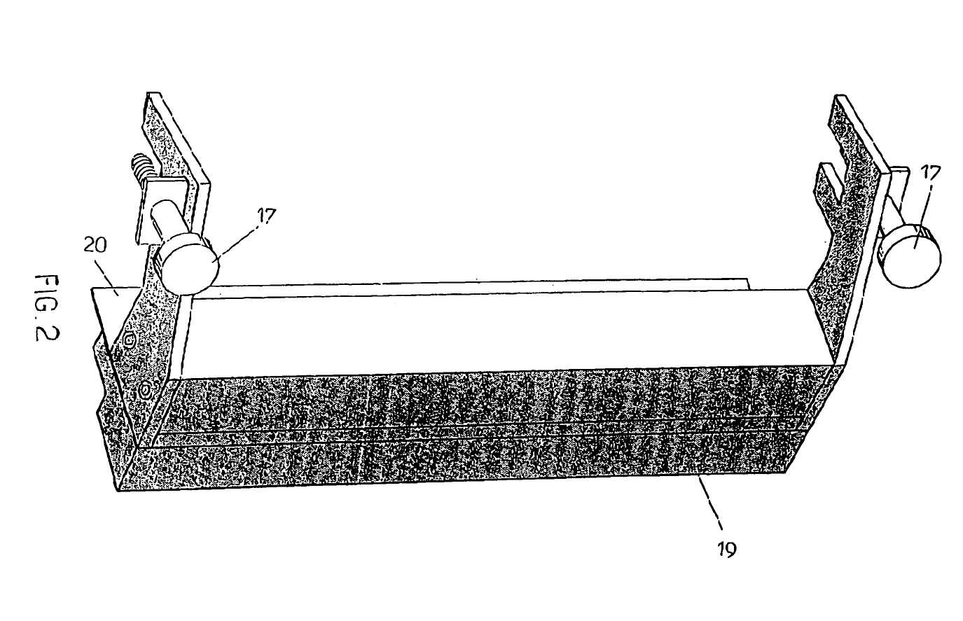

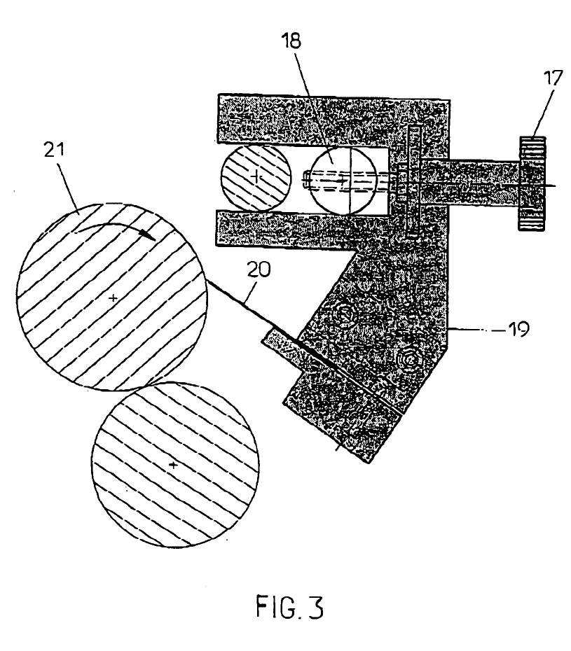

We can notice from FIGS. 2 and 3 that the cleaning by scraping devices 19 are equipped with hard metallic scrapers 20 that have a sharp angle scraping edge, that is slightly softened with a plane or rounded surface by few hundredths of millimeters and polished with a polishing pad for instance thus allowing to eliminate any micro smudges and avoid any chance of harming the user. These scrapers are made with hard, stiff and flexible materials, such as a metallic blade, with a thickness of few tenths of millimeters in general, capable of breaking and scraping mechanically “by cutting”, with their sharp scraping angle and a previously adjusted light pressure, a film of residues as viscous and consistent as the one resulting from a typographic or similar oily offset printing ink without having to disperse prior to scraping.

These scrapers cooperate in an efficient manner with ink tables 21, which surface is adapted for such a usage to avoid any damage that might be caused by applied mechanical scraping.

A metallic scraper, such as a thin flashy steel, with a thickness of approximately two tenths of a millimeter, very soft, can eventually function with an ink table 4 of origin covered with a “rilsan” film, with no deep scratches, parallel to its axle, provided that its scraping edge be sufficiently rounded to work “by lamination”. That does not bring determined benefits compared to the soft scrapers and causes, nevertheless, risks when using metallic scrapers.

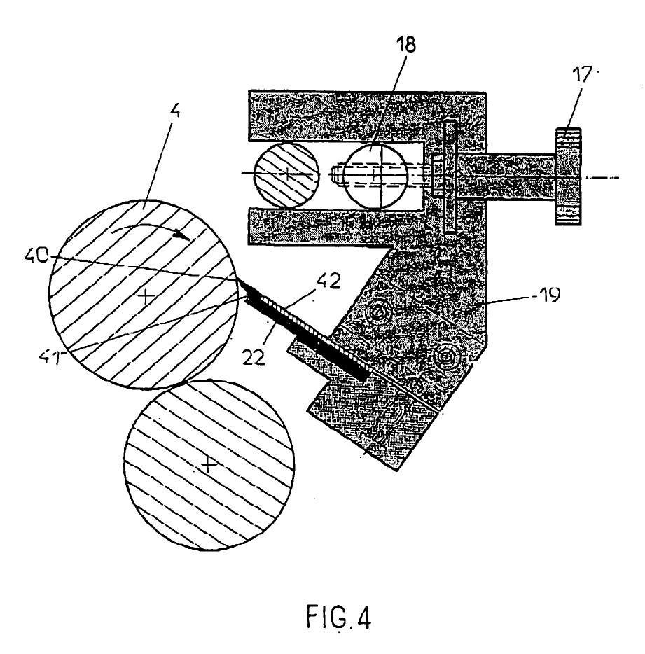

In FIG. 4 one can see a cleaning by scraping device 19, equipped with a hard scraper 22 which has, like in the case of the one made with metal, a sharp angle scraping edge made with hard, stiff and flexible materials, like hard plastic materials. These materials are selected in function of the way they are made; they could be made by molding, manufacturing, stretching, etc. These materials are, for instance, polyurethane or polyester, with a toughness that ranges between eighty five to ninety Shores D, or even vinyl polychlorure, polycarbonate, polyacetate, polypropelen, etc . . . Depending upon the nature of the material used and its mechanical incorporation to the cleaning by scraping device 19 as well, its thickness ranges between two to five millimeters. This hard scraper 22, like in the case of the hard metallic scraper 20 can, without any previous dilution, mechanically break and scrape “by cutting” clean, a film of residues of oily printing ink, offset, typographical or other. However, this hard scraper 22 is different from the hard scraper 20 by the fact that it efficiently works with ink table 5 of origin, covered with a “rilsan” film of which surface can have scratches and defects that are not deep. This hard scraper 22 is mainly characterized by the fact that the active zone in its scraping profile has an elastic stiff bending based upon a “form effect” associated with and combined to the variable nature of the material used. The angle, the shape and the thickness of its scraping edge 40 determine the capacity of a stiff bending, slightly elastic over few tenths of millimeters, thus allowing bearing and absorbing, without any abnormal wear and tear, the scratches and defects of the surface of ink tables 5 of origin. However, the form of the section of profile 11 determines its aptitude to regularly lose its longitudinal shape, in a stiff and flexible fashion, thus allowing it, at a previously adjusted measured pressure, to closely fit all along its length, the ink table 5 or 21, with which it cooperates, in order to obtain a regular scraping. The section of profile 41, made in a rounded shape, is very beneficial for the obtaining of a flexible, very regular bending, preserving a good rigidity, because this rounded section regularly spreads the pressure that is exerted by the non bendable scraper that can be, for instance, rigidified, if necessary, depending on the nature of the material used, with a stainless steel sheet 42 with a thickness close to one millimeter.

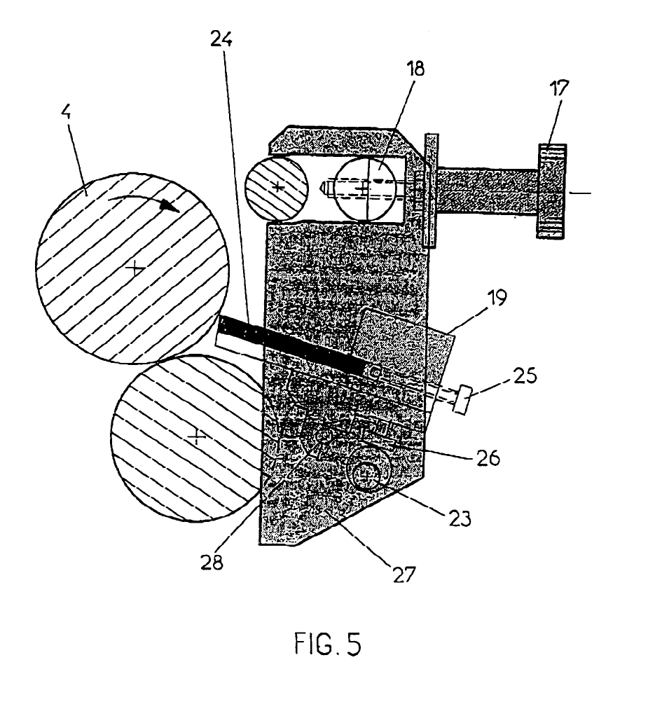

In FIG. 5 one can notice cleaning by scraping devices 19 that are equipped with semi-hard scrapers 24 with a very stiff, sharp angle scraping edge that can, without any abnormal wear and tear, bear an elastic bending that results from the nature of the hard elastomers used, allowing it to cooperate in an efficient manner with ink tables of which surfaces can have more significant scratches and defects than the used ones with hard scrapers 22. These scrapers, or at least their active scraping parts are executed by molding, manufacturing or other with materials such as polyurethane or polyester elastomers or any other kind of material with which one can obtain a sharp scraping edge that is slightly bendable, with a strong mechanical resistance to abrasion and to oily solvent inks, of which degrees of toughness range between seventy and eighty shores D.

These semi-hard scrapers 24 have also the characteristic of having their active scraping parts designed in a way that offers rigidity, resistance and mechanical holding all along the length and up to very close to the sharp angle of the scraping edge so that they could bear and transmit a sufficient pressure that will allow them, through their rigidity, their sharp scraping angle and their previously weighed pressure, to mechanically break and scrape “by cutting”, yet in a less clean fashion compared to the case of hard scrapers 20 and 22, a film of residues that is as consistent and viscous as an oily, offset or other type of inks, provided that, in most cases, the consistency and viscosity be reduced with a low previous dispersal.

As much as possible, the active part of these scrapers is located underneath the axle of the ink tables, in order to benefit from the lower round shape of these ink tables, and free the sharp scraping edge and consequently be able to strongly increase the angle in order to give it a higher rigidity and mechanical holding. This angle itself could vary from approximately ninety to forty five degrees, depending upon the toughness of the active part of these scrapers. Such toughness is determined by their location with respect to the ink table axle and also by the surface that is more or less damaged. With the same objective of freeing the sharp scraping angle, the angle of these semi-hard scrapers 24 is, while functioning, of a minimum of approximately fifteen degrees below the horizontal. Depending on the available location in the various types of printing press to be equipped, it becomes sometimes necessary, for establishing the cleaning by scraping device 19 that is brought to replace the de-inking device of origin 13, to have to position the active part of these semi-hard scrapers above the axle of the ink table 4, which requires, depending on the possible height, length and angle of these semi-hard scrapers, that the angle of their scraping edge be of approximately thirty degrees. This will require strengthening and rigidifying these semi-hard scrapers up to very close to their active scraping part (approximately one to three millimeters), with for instance either a metallic frame made with a steel sheet and a spring, or by over molding the active part of these semi-hard scrapers 24 that is made in an elastomere of approximately seventy shores D with an elastomere of approximately ninety shores D, that will thus transmit to it its strong rigidity, toughness and flexibility very close to its active zone of scraping. Despite their lower toughness these semi-hard scrapers as used, partially keep, thanks to the strong rigidity of their scraping edge and general mechanical holding, the advantages of hard scarpers 20 and 22 because they allow, like the latter, to scrape during the entire cleaning of the oily and consistent residues operation, not anymore “by lamination” but “by cutting”, according to the terminology used to characterize and differentiate the functioning mode of the invention with respect to the present technique and furthermore to work, with ink tables that have a surface state even very mediocre. However, the semi-hard scrapers 24, that are less efficient especially when they are positioned very much above the axle of the ink tables and consequently have a lower sharp angle scraping edge equal to forty five degrees, thus making them lose part of their mechanical holding and resistance, require, in the beginning of the de-inking operation, and prior to scraping, a previous dispersal of the oily ink residues. This dispersal is optional with the hard scrapers 20 and 22. Like the hard scrapers 20 and 22 the semi-hard scrapers 24 have a polished surface of their scraping edge, active part and make with the ink tables with which they cooperate, a coherent mechanical set that brings an efficient scraping function.

The more the sharpness of the angle of their scraping edge is higher, the better is the outcome. Therefore, a semi-hard scraper 24 with an approximate toughness that ranges from seventy to eighty shores D and a scraping edge with a sharp angle of approximately ninety degrees is able to scrape positively, without any previous dilution, a good amount of offset or similar printing oily ink (amount that is lower than the one obtained without any previous dilution with hard scrapers 20 or 22. This would not be possible with the same type of semi-hard scrapers 24, even if it is strengthened very close to its scraping edge, but has a sharp scraping angle of thirty degrees and therefore will require a slight previous dispersal of the residues prior to scraping, and that is the reason for which it is important to well define, in function of the presses that need to be equipped and of the available location for the installation of these cleaning devices, the best possible compromise among these various parameters.

The main advantage offered by these semi-hard scrapers 24 compared to the hard scrapers 20 and 22 is the ability to function, in accordance with the functioning mode resulting from this procedure, with ink tables that have a surface in bad state, yet knowing that if these ink tables have deep scratches parallel to their axle, the usage of these ink tables should be excluded and must be replaced. The set of hard scrapers 20 and 22 and semi-hard scrapers 24 is designed in a way to exert a sufficient minimum pressure in order to perform a good scraping. This pressure is weighed and previously adjusted while changing the shape, the thickness and the geometry of the scrapers, which avoids any excess of pressure that is harmful to their good functioning and any abnormal wear and tear for both the scrapers and the ink tables.

These semi-hard scrapers 24, working “by cutting” with a significant sharp scraping angle, close to ninety degrees and a slight inclination, and not working as usual in longitudinal flexion, consequently require, in order to function in an appropriate manner, a good quality of their mechanical execution and of their tools of adjustment and tuning precise in pressure, in addition to a parallelism with respect to the ink tables so that they would be able to cooperate in an appropriate manner with them.

The set of hard scrapers 20 and 22 and semi-hard scrapers 24 that work “by cutting” allow the usage of liquid, oily, lubricant and other de-inking agents, without having to add, neither before nor during the course of functioning, additives such as water or de-inking, cleaning and maintenance “gelled” products from liquid to solid. And at the end of the de-inking operation only an infinite oily, lubricant or other film is left on the surface of the set of rolls and ink tables that belong to the inking group and that does not disturb the following inking and favors the non fixing of residual micro-particles, between each successive printing.

In summary, the metallic hard scrapers 20 work with maximum efficiency in combination with the ink tables 21, the hard scrapers 22 with ink tables 21 or 6 covered with a “rilsan” film of which surface state should be examined before usage and reset for ready position if possible and the semi-hard scrapers 24 with ink tables 6 of origin, even when the their surface is in relatively bade shape. In the spirit of simplification and rationalization of the de-inking, cleaning and maintenance function, all the cleaning by scraping devices, that are indifferently equipped with hard scrapers 20 or 22 and semi-hard scrapers 24, are positioned in rotation on the pins 28 and made removable with a single motion, by revolving the eccentric axle 23, in a way to free the exerted pressure on the pressure adjustment screw 26, while preserving the initial pressure of these scrapers with respect to the ink tables. The eccentric axle can be indifferently controlled either manually, pneumatically, electro-mechanically, etc.

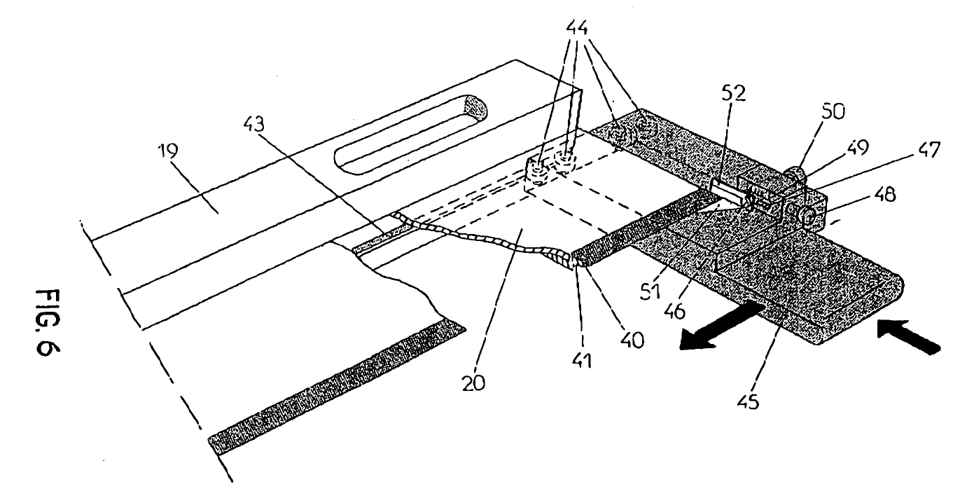

One can see also from FIG. 6 some means of adjustment tools for parallelism 25 and pressure 20 of the semi hard scrapers 24 that do not allow, given their positioning with respect to the ink tables 4 or 21, to work in longitudinal flexion.

Rigid flasks are permanently placed on the press in order to allow a swift positioning and a precise and repetitive functioning as well of the cleaning by scraping device 19.

The ink tables 21 in FIG. 3 are characterized by the fact that they have good oily properties, a surface that is finely straightened and smooth, a strong mechanical resistance and a good friction coefficient that allow them, without any risk of abnormal wear and tear, to be scraped by hard scrapers 20 of which sharp angle scraping edge can be made with materials that are as hard as steel. As a non restrictive example, these ink tables 21 have the benefit of being of being made of steel allowing them to reach a surface toughness of approximately sixty Rockwell.

Ink tables 21 and metallic hard scrapers 20 make a set allowing the optimization of the scraping function. The appropriate geometry of this set, the finely straightened and smoothed surface of the ink tables 21 and the sharp angle of the scraping edge of the metallic hard scrapers 20, allow, at a low weighed previously adjusted pressure, to obtain at each turn of the ink table 21 covered with a film of residues, the extraction of a maximum of residues, and thus unlike the present case avoids, at each turn of the ink table 4, a good part of the residual film from returning to the inking group. The combination of these various tools optimizes and accelerates the scraping operation and quality, regardless of the products or solvents used. Consequently, we obtain at the end of the cleaning process, a real “wiping” by mechanical scraping of the ink table 21, while leaving, through transfer, only an infinite oily, lubricant or other kind of film for the set of rolls and ink tables.

In FIG. 6 one can see a scrapers grinder working in combination with the cleaning by scraping device 10 that allows the brightening up of the sharp angle of the scraping edge 40 of the hard scrapers 22 or semi-hard scrapers 24. This grinder allows the printer to continuously use scrapers that are in very good functioning shape, for many years, unlike the soft scrapers 15 (in FIG. 1) of origin that have a life term of usage, when in good functioning shape, of few weeks. The fact of preserving the angle of the scraping edge of these scrapers in a sharp shape allows reaching a rationalization of their usage and time and appreciable cleaning products saving. The grinding of the sharp angle of the scraping edge is easily made with one motion.

As a non restrictive example, this grinder works as follow: the cleaning by scraping device 19, equipped with a hard scraper 22 or a semi-hard scraper 24, has guiding grooves 43, cart moving wheels 44, removable tool carriers 45, over which is installed the cutting tool 46, sliding inside the light 47, over which it moves through the micrometric adjustment screw 48 attached to the vernier 49 that can be for instance made with two metallic blades, the lower one 51 is severing and the other one 52 is non severing. The lower severing blade 51 is positioned in the same angle than the one of the scraping edge to be ground. The non severing blade 52 is slightly leaning over the hard scraper 22 or the semi-hard scraper 24 and its function is to maintain and pinch the scraping edge 40, in a way to machine it by moving the tools carrier cart 45 that is leaning on the groove 43, thus making an angle that is perfectly sharp with no smudge whatsoever.

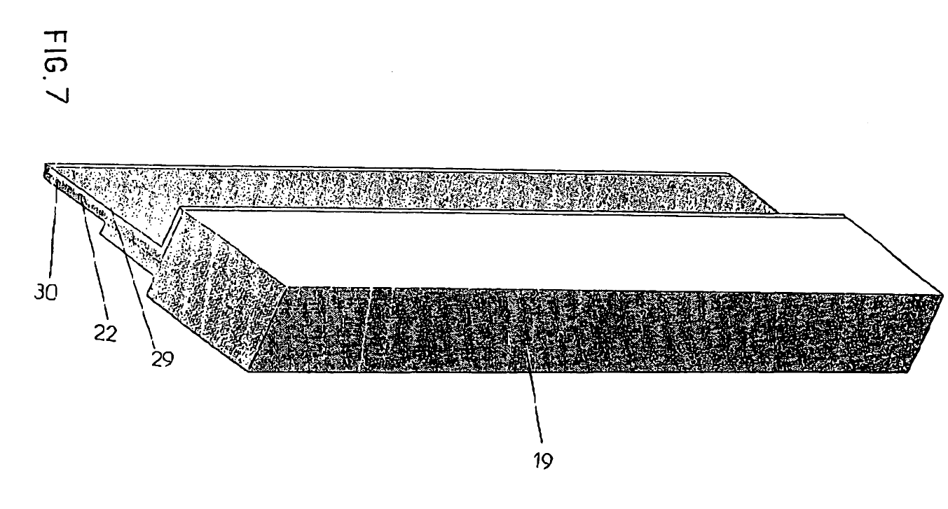

In FIG. 7 one can see a cleaning by scraping device 19 of which the hard scraper 20 or 22 or the semi-hard scraper 24 is covered, prior to usage, with a disposable casing 29 characterized by the fact that it is kept in place, prior to usage, with for instance a permanent adhesive 30 that can repositioned in order to allow the disposable casing 29, following usage, to be easily detached from the scraper. These disposable casing 29 can be made with materials such as very tight textured paper, layered paper, etc. The part of the semi-hard scraper 24 or of the hard scraper 20 or 22, covered with the disposable casing 29, is made less thick of almost five tenth of millimeter with respect to the disposable casing 20 and that in order to facilitate the out flow of the residues. The permanent adhesive 30, set in the gluing zone 31 over a width of approximately ten to fifteen millimeters, on the back of the disposable casing 29 can be replaced, when necessary, with any other tool allowing it to stay in place during the cleaning operation/s, like for instance with an oily film or a steel sheet, inserted between the disposable casing and the scraper, pinching an additional crease on the disposable casing, in the area that is previously maintained with an adhesive film or other. These disposable casing 29, covering the hard scrapers 20 or 22 and the semi-hard scrapers 24 are of very low cost, very useful and can adapt to all types of printing presses. They can be set and removed with a simple motion, they are biodegradable as well, they can also be easily stored following usage with the intention of destroying them later; they also compete, in the same manner as the other means brought by the procedure, to allow an increased simplification, rationalization and automation of the cleaning function, which are factors that represent important objectives for this procedure.

The fact of thinning out the hard scrapers 20 or 22 or semi-hard scrapers 24, very close to their active scraping part offers various additional possibilities of swift residues recovering, like for instance the one represented by replacing the disposable casing, should the operator opts not to use them, with a removable metallic pot or other that are easily cleanable outside the printing press.

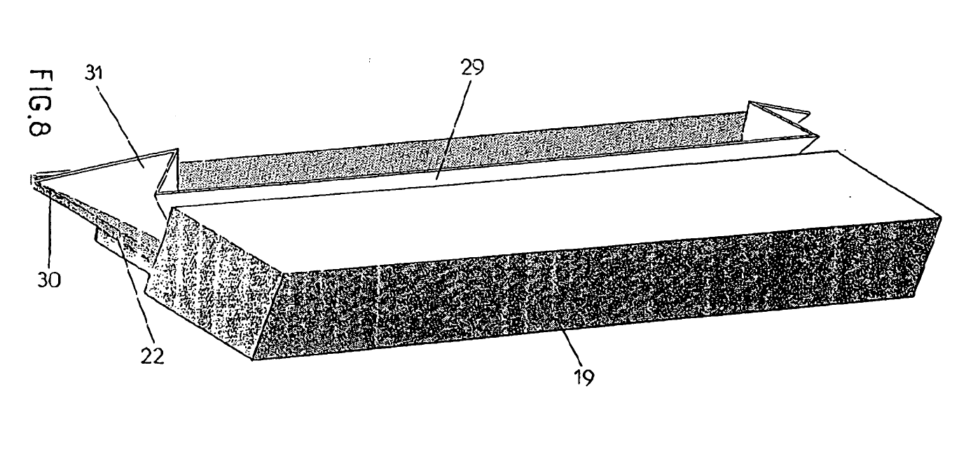

One can see in FIG. 8 an example of the shape of the same disposable casing 29, that has in addition to two bellows 31 in the shape of V or other, conveniently obtained by simple folding of the paper sheet or any other material. These bellows 31 transform the disposable casing into a pot that is able to contain the residues and thus allowing a performance of close to fifteen cleanings before being replaced.

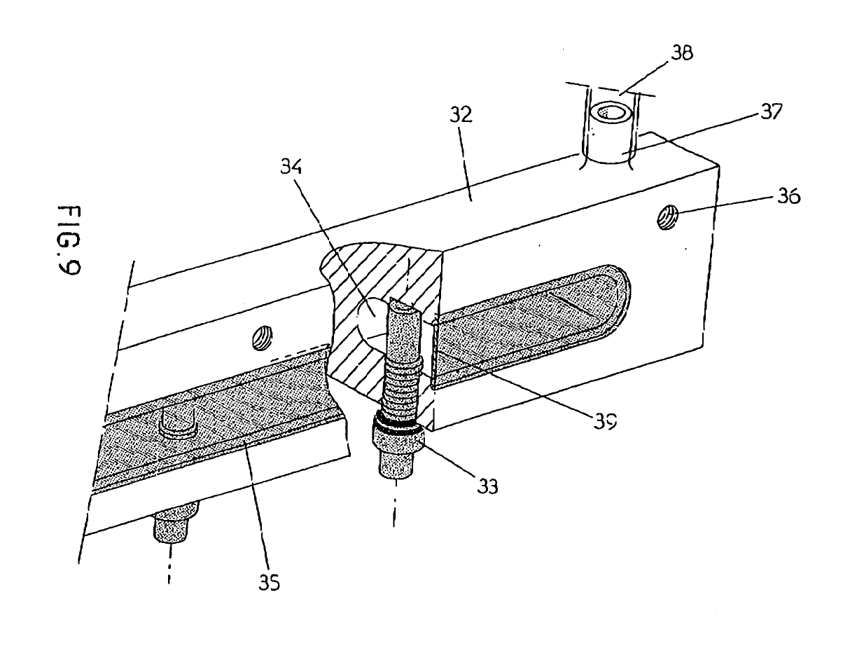

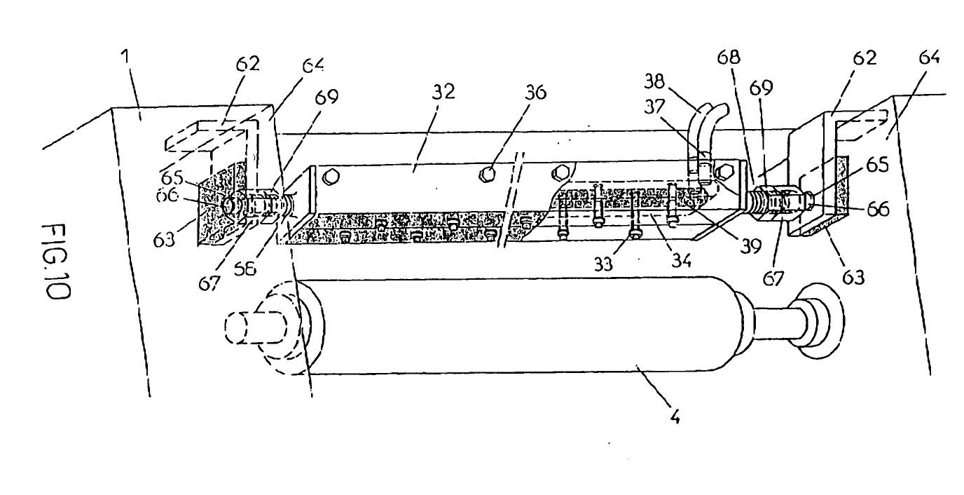

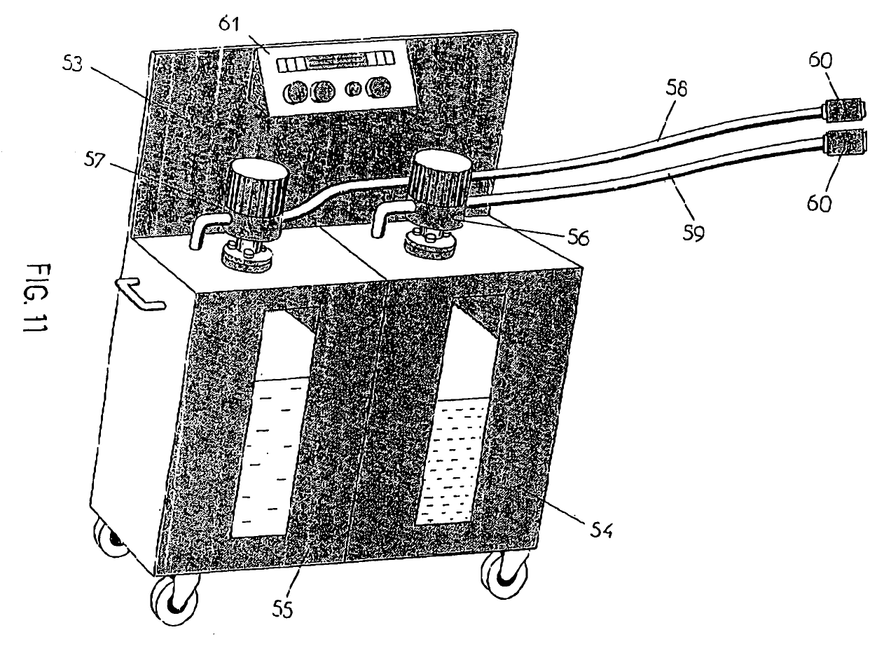

FIGS. 9 and 10 show cross-sectional and face drawings of an automatic distribution ramp 32 of the liquid de-inking agents or de-inking, cleaning and maintenance products “gelled” from liquid to solid. This figure illustrates a non restrictive example.

These distribution ramps 32 are characterized by the following facts:

their distribution conducts 33, depending on the viscosity and state of liquids to be treated, are lightly fed above the feeding conduct 34 in such a way to eliminate, when not in function, any chance of parasitic out flow that is common to this type of ramp,

their feeding conducts 34 have a very small section, approximately fifteen square millimeters, in such a way to limit the quantity of liquid,

these automatic distribution ramps 32 have a very small thickness, approximately fifteen millimeters and are side by side with one single joint for water-proofness 39 for two ramps, located in the groove 35, in addition to joining screws 36, their basis of distribution 33, with the objective of standardizing their production, regardless of the liquid used, and of avoiding any costly and difficult production, as a result of the low diameter piercing of approximately two to four tenths of a millimeter, over lengths that are over three to four millimeters, are conveniently pierced with a diameter that ranges from approximately one and a half to three millimeters. An out flowing moderator of any type is introduced inside this conduct resulting from this piercing. This moderator can have the shape of a fuse with a previously determined porosity in function of both the liquid to be treated and the required flowing. This out flowing moderator offers also the advantage of eliminating or slowing down the filling of the distribution conducts 33 and of avoiding any air intrusion inside their conduct, when these distribution ramps 32 work under empty air. In order to avoid any over loaded drawing these out flowing moderators are intentionally not represented.

their feeding connection 37 allows, with the pipe 39, to be fed in any mode of feeding: a) through gravity by either using a manual control like a faucet, or by using for instance distribution conducts 33 allowing a dosed distribution, through drops, of which flow is previously adjusted through either changing both their shape and the section of the conducts or also by using tiny electrical gates subjugated to all types of control tools with distribution conducts 33 that eject at a low pressure fine jets that allow at each impulsion a sequential distribution of about one gram of product by linear meter. b) through pressure, for instance, of small pumps of which flow and pressure are adjusted to the various types of products to be treated and to the distribution conducts 33 used.

These distribution ramps 32 are conveniently equipped with quick connection tools that allow them, without any mechanical intervention such as piercing, tapping or other, to be positioned at any spot of the printing press I FIG. 10.

As a non restrictive example, these tools are made of support angles 62 set at each end of the distribution ramp 32 over which is maintained an antiskid skate 63. This support angle 62 contains a positioning hole or oblong 65 for the distribution ramp 32, in which is introduced a centror 66 of the blocking nut 67, operating with the threaded rod 68 positioned at each side of the distribution ramp 32. Upon connection, and in order to keep in place the distribution ramp, once positioned, one needs to unscrew the blocking nuts 67 and introduce their centrors 66 inside the holes or oblongs 65 of the support angles 62 of which anti-skidding skates 63 are strongly leaning on each of the two faces of the printing press 1 frame 64. The counter-nuts 69 are used avoid any accidental wandering of the nuts 67.

By virtue of their easy mechanical execution these distribution ramps 32 are of low cost and by virtue of the universality of usage they allow indifferently the usage of any oil, solvents or oily or non oily diluents in addition to all kinds of gels, detergents, washing products, water, etc. while offering the possibility of placing them next to each other, in a small space, all of this make them able to integrate in the rationalization and automation resulted from this procedure.

From these distribution ramps, one can, for instance, obtain a strong de-inking action and a thorough cleaning of all the elements that make the printing group, by distributing a simple diluent for general de-inking followed, either simultaneously or alternatively, by a detergent such as soap or any other, thus causing an instantaneous “gelling” with the diluent making a viscous gel, causing the detergent and the mechanical chemical reaction a strong cleaning action followed or not, depending on the water concentration of soap, by a simple water rinsing.

Several combinations of cleaning, obtained at a low cost, are the result of the usage of these distribution ramps 32, that easily integrate into all types of printing press and allow, by their dosed product distribution, to successfully resolve all problems that occur in this field of usage.

It is to say that if it is easy to distribute, as in the present case, in a relatively large quantity of liquid agents by intermittent jets, from the distribution conducts with big section, distantly spaced from each other, it is much more difficult to regularly distribute, in very small quantities close to few centigram per conduct. There are more sophisticated and costly means to obtain a very small and slow alternative or continuous distribution of the products used, however their cost limits the development of the automation of the cleaning function.

One can see in FIG. 1 a mobile support 53 that allows the implementation of a set of common cleaning functions for the different printing presses and materials, of which time of execution is relatively short with respect to the other printing functions. These mobile supports were designed to rationalize and reduce the cost of the cleaning function while, through their variable capabilities, benefiting a set of printing materials. They are made, for instance, of one or several storing containers 54 of different agents and products, a water container 55 or added water, respectively equipped with dosing pumps 56 and 57, and feeding tubes 58 and 59 of the distribution and rinsing ramps. The quick connections 60 are hooked with a single motion to the feeding nozzles of these distribution and rinsing ramps. The computerized control desk 61 manages all the de-inking, cleaning and maintenance functions. These mobile supports distribute and can as well mix, in order to “gel” them, all products and agents usable for the cleaning of the elements necessary to the set of the printing function.

The additional function that results from this cleaning process that allows the automatic cleaning, simultaneously with the inking group, the soaking group, the offset printing plaque, the printing cylinder blanket and the counter-pressure cylinder, is essentially due to the usage in combination of cleaning devices that have strong scraping capabilities and to the de-inking liquid agents and “gelled” non volatile de-inking, cleaning and maintenance products, but having on the contrary properties that are oily, lubricant, and non harmful so that they will not attack these various elements, and distributed in a controlled manner and is obtained by momentarily authorizing, with all possible means during that function, the reconnection of these various elements, which normally do not connect or press except during the printing cycle. Various tools could be used in order to obtain this result depending on the kind of presses to be printed, sheet to sheet or continuous tape used. As a non restrictive example, a simple tool consists of temporarily shunting the switch working in combination with the detector of no sheet picking, instantaneously stopping, in the course of printing, the printing press. One can also easily shunt the detector that detects any intrusion of a parasitic air at the level of the clip that picks the paper. De-inking agents that are characterized by the invention, are of all types and can be, for instance, oily solvents or diluents of vegetal origin that are used without any additive like water, such as colza methyl ester. These substances are currently recommended and used like bio-carbon, bio-solvent or bio-diluent, etc. and they are by nature biodegradable, renewable and of a relatively low risk which makes their usage approved by the Recommendation of the International Directives as to these substances and preparations. These esters used as such or added as previously explained with additives intended to strengthen their detergent properties or serving as a diluent base and eventually of an agent that triggers the ‘gelling” of the de-inking, cleaning and maintenance “gelled” products, are technically very valid to this application. However at the present time their price is higher than hydrocarbon diluents of similar grade and consequently creates a good reason for not using them. Through this procedure that allows the usage of high grade oily diluent with zero or very low rate of aromatics (aromatics represent in the hydrocarbon diluents the most harmful solving function, useless by this mode of functioning), the usage of this type of diluents that are not classified because they cause very little nuisance and dangers of all kinds, is in many cases very acceptable and generally in accordance, at the present time, with the set of Directives in connection with these substances and preparations. The oily molecules of oily diluents and solvents are combined with the oily molecules of the oily printing inks residues and consequently accelerate their soaking and transfer thus reducing as well the consumption of these diluents with respect to the light solvents. By the same token, their sequential slow dosed distribution allows the residues to absorb these diluents before they get scraped, thus avoiding that a good part be scraped before having adequately fulfilled their function. Such a way of proceeding brings a considerable additional consumption saving. The aforesaid de-inking liquid agents are mainly characterized and claimed through the present procedure, because on one hand they do not transmit any volatile organic components (VOC), or at least they are in compliance, in this respect, with the Directives and Norms of the International Organisms, while taking into account, in their costs and possibilities of supply for all the concerned countries, the set of other Directives of these Organisms in connection with these substances and preparations, and on the other hand the fact that they can be used in either their oily or lubricant state, without having to be mixed or emulsified with additives such as water in combination with the cleaning devices and distribution mode of the invention. These de-inking agents are also characterized by the fact of being closely mixed with oily printing residues, by dispersing them while keeping their homogeneity and by giving them a state that would take away their excess of stickiness and dryness.

Some much oilier de-inking agents, such as vegetal diluent oils, with no toxicity are successfully usable by this procedure and make with soaps and some detergents very good de-inking, cleaning and maintenance “gelled” products for the rubber surfaces. These oils do not offer at the present time a real benefit through their usage by virtue of the fact that their consumption is slightly higher than lower grade products and because almost all oily printing inks are not biodegradable and require treatment for their destruction. However, in the beginning it is very important to eliminate any VOC emission and to reduce the amount of risks and harmfulness linked to light de-inking.

In practice and except for the simple functions of printing press de-inking where ink is directly reused after scraping, a slight distribution, prior to scraping, of liquid de-inking agents or de-inking, cleaning and maintenance “gelled” products is very useful because it allows, through neutralizing any excess in stickiness and dryness of the residues, their elimination from the cleaning device much easier and without any solvent or diluent.

These de-inking liquid agents and de-inking, cleaning and maintenance “gelled” products, depending on their destination, can also conveniently, given their ability through this procedure to scrape oily and consistent products, contain also, for instance, some regenerating agents of the rubber surface in addition to some neutralization agents of the minerals contained in the soaking waters that are needed for the offset printing. The aforesaid de-inking liquid agents, usable as simpler diluents, that contain little or no additives in order to reduce the cost, are well adapted to the general de-inking of printing presses working in color printing where each de-inking group indefinitely preserves its primary printing color and does not require, by virtue of this fact, unlike inking groups treating various color printing, a de-inking and cleaning that will allow switching from dark color to a light color, without having, as it is in the present case, to follow de-inking of the dark color and inking of the light color, to re-de-ink several times the same inking group in order to obtain a relatively clear printing. Another advantage of the ability to use heavy diluents or solvents compared to light solvents is the non necessity to dry up the rubber surfaces, by preserving them a tiny oily trace that does not bother the following inking but brakes the fixing, through dryness and sedimentation, of the residual micro-particles that make the glazing of the rolls surfaces. In this application and upon this procedure, an additional cleaning function, at least on a daily basis, is recommended for keeping the rubber surfaces in good shape.

The usage of de-inking, cleaning and maintenance “gelled” products is, as much as possible, recommended because the “gelling” function, even when very light, accentuates the ungluing caused by detergents and the coating and the additional mechanical action that result increase the movement of the residual micro-particles avoiding their redeposit.

The term “gelled” was kept and used in a broad meaning, to describe the and characterize in its requirements the set of various means used by this invention in order to obtain an additional cleaning and maintenance function, yet in this case, this term encompasses and regroups all types of substances and compositions, that have the properties of diluting and deterging the printing oily ink residues that are able to irreversibly unglue and to move the residual micro-particles while removing from these residues any excess of stickiness. These substances and preparations are out of VOC, they come in a state from liquid to solid to be distributed by either gravity or pressure and conveniently bring a certain consistency to the ink residues in order to better coat them and brake their out flow and create a higher mechanical detergent as well.

As a non restrictive example, these substances and preparations indifferently come as “gelled” diluent detergents, usable as such or as “gelling” in the course of the cleaning operation by mixing their constituents, of which viscosity is adjustable from very high to low, with little or non “gelled” milks like a diluent detergent emulsion, creams, pastes, foams, etc . . . The only retained criteria is that following de-inking, these substances bring an additional cleaning function.

Always within the frame of the invention, the specific properties that characterize these substances and their detergent “gelling” mode are of all natures and origins and can, for instance, be naturally acquired or can be the result of physio-chemical reactions or of adding agents such as thixotropent, “gelling”, thickeners, viscous agents, swelling agents, and other . . . , these means can be used either together or separately. A large line of all types of chemical means allows, from variable basic products selected in function of their nature, cost, easiness in supply or other, to produce detergent milks and lines of “gelled” substances, prior to the cleaning operation or “gelling” during the course of the operation for the convenience of the various usage cases resulting from the cleaning of the various printing materials and types of printing presses to be treated that print sheet by sheet or continuously.

In summary, these various de-inking, cleaning and maintenance “gelled” products, from liquid to solid, come, depending on their destination, under two main basic forms, that adapt to the scraping capacity of the available scrapers and the means of supply and the costs of these substances, in function of the various regions in the world, upon which many components would vary without affecting the present invention.

a) either, for instance, as a “diluent soap”, “gelled and oily, obtained by a simple mixing of soap and diluent, provoking, through instantaneous physio-chemical reaction, a viscous “gel”, sticky and stiff, of which viscosity, stickiness and rigidity generate a strong mechanical cleaning reaction through lamination of the residues, mixed by pressure to the lines of contact of the rolls and ink tables. This action, combined to the twinned action of diluent and detergent cleaning agents, provoke an ungluing and irreversible moving of residual micro-particles. Thus, allowing their maximum extraction from the rubber surface of the rolls and the printing blankets, keeping them in a clean state and stopping any premature “glazing” and any wear and tear. This additional mechanical cleaning action, depending on the density and stickiness of the “gel” used, is an important factor for the cleaning and maintenance of the printing material by scraping, because the mechanical action presently brought through the usage of light de-inking solvents, compared to the one obtained through this procedure, is insignificant.

This type of “diluent soap”, “gelled”, oily and sticky in addition to any composition that provokes a similar result can not be used, in a sticky state, with traditional soft scrapers because they could have an abrasive effect in a very short time to their active scraping part on the ink tables over which they work together,

b) or, for instance, as a light “gel” or detergent milk more or less consistent, depending on their destination, resulting, for instance from the association of oily diluents, that can be conveniently of the same nature as the de-inking agents and the detergent agents as well such as dispersants, emulsioners, emulsifiers, soakers, and others, that, depending on their natures, physio-chemical reactions and destinations, will or will not contain “gelling”, thixotropent, thickeners, viscosing agents, etc. These “gels” or milks, depending upon their composition, can also be used, if necessary, with traditional soft scrapers, by using, in the case of detergent milks that are formed in their natural environment by the printing press, the means of distribution of the invention allowing the right proportioned dosage of these detergent milks components, knowing that their consumption with respect to the “gels” used with scrapers working at cutting, is much higher.

As it was previously explained, the set of different “gels” or diluent detergents is conveniently made of watery detergent, because the latter brings, through water rinsing, a physio-chemical repulsion entailing a non redeposit of the fixed oily residues on the organic materials such as rubber and “rilsan” and lightly offer, cost efficiently, a good rinsing and cleaning agent. These various de-inking, cleaning and maintenance “gelled” products or milks with watery detergent base, are also formulated in order to obtain the evacuation of residues through water rinsing thus allowing, by eliminating the usual solvents for this function, to perform at low cost the entire automatic cleaning by scraping or successive dispersal in a solvent environment of the set of the printing presses elements and must, when used as such, have their watery detergent functions highly strengthened, in such a way to sufficiently break down the ink residues and the rinsing water used and to conveniently contain all types of detergent agents, such as detergents working in combination with “gels” and milks. The diluents or oily liquid solvents used through this procedure to serve as general liquid de-iking agents or to serve for the making of “gels” will be conveniently selected from the biodegradable agents, little harmful, even if their action is strengthened by using them in association with a cleaning product working in combination with these oily diluents and solvents because if the use of more active oily solvents or diluents, non VOC and more or less biodegradable is possible through this procedure, such as EDB (ester dibasic), glycol ether, phenoxythanol propanol, etc . . . Their usage is in general more harmful and toxic and their strongest solving action dries up the rubber surfaces and attacks their laminators and the photosensitive layers of the offset printing plaques making them as such unusable. This inconvenience is so harmful that at the present time many printers de-ink the soaking group of their printing presses simultaneously with the inking one, by using the offset printing plaque as a mean of connection between these two groups. Through such a usage, the de-inking device of the inking group fills, by itself, this double function. On the other hand, despite their strong solving and diluting actions, these oily solvents and diluents do not provide a good cleaning action compared to the one resulting from the usage of less harmful solvents or diluents combined with the detergent agents and tools of this invention.

De-inking, cleaning and maintenance “gelled” products can be distributed through one single source of distribution, for instance, by using a single ramp of distribution or a dosing bottle equipped with known tools of dosage. In this case, the product is distributed in its final state where the set of constituents were previously mixed. These de-inking, cleaning and maintenance “gelled” products are also characterized by their ability, upon request, to be delivered as concentrated “gelled” or detergent that do not contain the agent/s that provoke “gelling”. These agents can be, depending on the selected composition, either water or water mixed with additives that strengthen its detergent properties, or also one or/and the other diluent detergent agents. In this case of usage, the “gel” or milk is prepared prior to usage by the user or during the cleaning operation by using the set of rolls or ink tables that belong to the inking group as a mixer of the de-inking and detergence agents to naturally form at the end of the cleaning operation, a good quality de-inking, cleaning and maintenance “gelled” products. This type of procedure that allows, when needed, to obtain “gel” from liquid to solid, with an adjustable viscosity and stickiness, depending on their destination, requires two sources of distribution, of which flows can be differently dosed, offers the advantage of having to distribute only liquid agents, of which life term is almost unlimited and allows, during the de-inking phase to distribute only the general de-inking agent. The latter fact allows, in an economic fashion, with the mechanical scraping tools, the rapid evacuation, with little detergent agent, of the quantity of residues. The cleaning phase is connected to the de-inking phase by distributing, for instance, in respectively good proportions the detergent and the diluent. Both diluent and detergent distributions instantaneously provoke the detergent “gelling” or emulsification, causing the ungluing, moving and scraping of the last residual micro-particles. In this case of usage, each of the agents used have only one single function which is either diluting or deterging, which is not enough for a good cleaning function. Their combination makes this function tenfold, by generating an additional cleaning function. This latter way of proceeding offers the printer the option to either provoke or not the cleaning and maintenance function at his discretion. The latter is determined by the fact that successive printings to be done will or will not have close tones and will require to directly obtain a clear color without having, like in the present case, to de-ink several time the inking group.

Through this procedure, the printer has at his/her disposition cleaning and maintenance tools of his/her printing rolls and blankets and will have, in order to keep them in a good functioning state as long as possible, to thoroughly clean them, at least once a day given that, once this time frame is over, the low oily film being in the surface and inside the micro-porosity of these rubber rolls and blankets, delaying the dryness of the ink residues, will not possess the sufficient action of avoiding the fixing process.

Taking into account that the additional cleaning action requires a short time, which is, depending upon the printing presses, close to three minutes, and that such action allows the thorough extraction of a maximum of residual films of the micro-porosity of the rubber surfaces, and that this important factor assures a longevity to these rubber elements while representing a determining factor for the printing quality and easiness and that this function requires only few grams of soap or detergent and diluent of a relatively low cost, its repeated usage is recommended.

As far as the de-inking agents used on printing presses in a four or more color process, in which each inking group prints in the same color, a slight addition of an anti-dryness ink agent will be usefully used added to these de-inking agents, given that these presses often work, intensively, in two or three services with highly drying printing inks, such a precaution in case of forgetting the cleaning operation will slow down the glazing of the rubber surfaces.

Through this procedure one can as well, in a rational fashion, use the light oils emulsion with approximately fifty percent of water provided that these products have good detergent properties. In these conditions of usage it will be sufficient to use light oils as simple diluents to be used without water in order to carry out the total de-inking function and to then distribute, following a last oil distribution, only a small quantity of rinsing water that is dosed and proportional to the oil distribution achieved for ungluing and moving the last residual particles. In this case of usage and through this procedure, the usage of a simple de-inking diluent, followed at the end of the de-inking operation by a distribution of water mixed with a detergent agent that mixes with the diluent, is more rational and less expensive compared to the use of light oils that contain emulsifying agents.

The fact to be able, through this procedure, to eliminate the successive need to use oil and water radically changes the use of these oils and avoids the risks from these disorganized successive distributions. These light oils can be, palliative as they are, used in a more rational and efficient manner than now, even with soft scrapers, by using the dosed distribution means of this procedure, knowing that the consumption of light oil will be much higher than with the cleaning devices of this invention but they will bring at least the elimnation of VOC.

As an example we are giving here two schematic profiles of the composition of de-inking, cleaning and maintenance “gelled” products. In the first given example, during the course of the de-inking and cleaning, the “gelled” or “gelling” product is a result of a physio-chemical reaction that provokes, through mixing, a stiff and sticky “gel”, that brings a strong mechanical action of cleaning through irreversible ungluing and moving of residual particles. This “gel” is, among other things, particularly interesting by the fact that it is the result of the combination of a simple de-inking agent and a soap.

Depending upon its destination, its water solubility can be highly enhanced by changing the proportions of these components in favor of detergent agents and by adding, if necessary, rinsing water, additives thus enhancing the soaked residues. This kind of “gel” allows carrying out, at a cost-efficient price, the various cleaning functions required by the invention. This “gel” can with the cleaning devices used through this procedure, carry out a good de-inking and cleaning of the inking, offset printing plaques, cylinders blankets and counter pressure cylinders. It allows obtain as well the evacuation of the ink residues by a simple water or detergent product rinsing in addition to a good cleaning by successive dispersal of residues in a watery environment, in addition to the de-inking and cleaning of all printing material.

This type of “gel” by thoroughly cleaning the offset printing keeps the latter intact.

In the second schematic composition of “gelled” or “gelling”, that is made of watery detergent as well, and as a non restrictive example, the “gelling” is a result of the combination of de-inking agent, detergent agents and depending on the cases of usage of thixotropent or other agents and of a percentage of water instantaneously triggering the ‘gelling” reaction or the thickening of detergent and thixotropent agents used. This gel, when made less active by changing its proportions can be used as a base for the “gel” allowing achieve the set of the objectives of the invention. The borders between these two types of “gels” are chemically close and based on these two examples all types of variants can result. One can, for instance make de-inking, cleaning and maintenance products come in the form of milks that are little or non “gelled”, with very strong properties of rinsing with water of the oily ink residues, by substituting the entire or part of the oily diluents with detergent product agents like “micronised” washing products that when associated with other detergent agents such as soaps or others, bring a strong de-structuring and movement of the oily inks.

In the case of cleaning the cylinder blankets, these watery “gels” eliminate the inevitability to have to, as in the present case, alternatively distribute solvents that are miscible with water and from water, made to loose the paper fibrous particles that are strongly attached by the oily ink under the required pressure for printing. These “gels” dilute, coat and move, without making them soluble, these fibrous residues and consequently brings a very good result. On the other hand, given the fact that they stay on the surface of the brushes that equip the automatic cylinder blankets washers, these “gelled” products, among other things, avoid the pollution of the hollows in the cylinder.

As a first example of “gelled” schematic composition, the product can be made of colza ester or of a hydrocarbon that is slightly of the same grade, and depending on the required more or less sticky “gelling” state, represents forty to sixty percent of the composition. The composition contains as well forty to sixty percent of soap like the ones resulting from the chemical reaction of amino over oily acids (soap that itself contains thirty to sixty percent of water). The colza esters or similar will be for instance by virtue of their relatively low cost, similar to the ones used as bio-carbons totally or partially the fuels in diesel engines.

In the second example of the “gelled” schematic composition, the product can be composed of tension active emulsifier with a high HBL, for instance derived from glucose, associated with few percents of dispersing, soaking and detergent agents, such as esters of ethoxylated sorbitols, sugared lipids, laurate methyl, etc . . . , the whole represents fifteen to twenty percent of the composition. The composition contains between fifty to fifty five percent of oily diluents like vegetal ester, distilled petroleum or others, in addition to twenty to twenty five percent of water and one to three percent of polar solvent.

Depending upon the required “gelling” and the substances used as well we use three to ten percent of all types of thixotropent, gelling, and thickening agents, such as organo-bentonite, cracked silica, hydrogenised castor oil, polymer, etc . . .

Finally two to three percent of the stabilizing and “gels” preservation agents are included.

Based on this last non restrictive example of schematic composition, all one needs is changing the natures and proportions of these various constituents in order to obtain “gelled” products or milks that can adapt to the various cases to be treated and used, among other things, with traditional soft scrapers, by associating to these specific milks and “gels” the means of distribution resulting from this invention.

When these multiple-component gels are produced during the cleaning operation it is, as previously explained, extremely important in order to obtain a good result that the distribution of each component be made in a sequential pre-established manner in the cleaning cycle, and be well dosed with the right proportions of the ones to the others.

All the advantages resulting from the de-inking, cleaning and maintenance procedure can be widely applied in the field of printing, because contrary to the very important techniques developments and improvements reached during the last fifty years in the field of printing presses and printing material equipments in general, the de-inking, cleaning and maintenance function has always been a little neglected compared to the other functions and the fact of rationalizing and automating in a cost effective manner this function, while eliminating the usage of toxic solvents and significantly reducing the consumption of liquid de-inking agents and de-inking, cleaning and maintenance “gelled” products as well is considered a great development. All we need to do in order to be sure of this fact is to consider the example of cleaning high production printing presses that work in four or more colors, continuously or paper sheet by paper sheet, that use on a daily basis between ten to twenty liters of light solvents in order to allow them to be able to appropriately continue printing. By equipping these printing presses with cleaning by scraping devices 19, equipped with hard scrapers 20 that are able to scrape, with or without a previous dilution, the significant amount of ink residues, the small remaining quantity of ink allowing usually the appropriate printing procedure or, if these residual inks are highly polluted or dry, to complete this general de-inking through the distribution of a small quantity of de-inking, cleaning and maintenance “gelled” products or milks. This significant example mainly based on the large savings of solvents that it brings in addition to the elimination of VOC, yet represents only a small number of the myriad advantages resulting from this invention.

All the means previously described fit in a flexible fashion by either substituting the original de-inking devices or by any kind of placement on all types of printing presses that are already in service or are to be built, printing by either paper sheet by paper sheet or continuously, of which printing capacities can vary from the small office press to the large rotary press.

1. Printing press de-inking, cleaning and maintenance procedure, that is characterized by being able to directly scrape the ink tables or rolls of the printing inking without any previous dilution, with liquid de-inking agents or de-inking, cleaning and maintenance products that are ‘gelled” from liquid to solid, the scraping being provided with at least hard or semi-hard scrapers. The aforesaid agents or products are distributed without emitting any volatile organic components, all along the scraping operation, upon a small dosed flow that is dosed and noticeably proportional to the scraping capacity of the hard and semi-hard scrapers and by using the residues as thickening substances of the liquid de-inking agents in order to preserve the residues a good consistency.

2. According to claim 1, de-inking, cleaning and maintenance procedure that is characterized by the fact that the de-inking, cleaning and maintenance products are gelled products that bring an additional cleaning action through detergence, from a liquid to solid state with an internal consistency that is naturally acquired. The latter is a result of a chemical reaction or provoked by adding gelling agents, thixotropents, thickeners used separately or together and that the components of these products are combined together and contain dilution and detergent agents of the oily printing inks such as oily diluents, soaps, emulsifying agents, emulsifiers, dispersals, soakers.

3. According to claim 2, this procedure is characterized by the fact that the aforesaid de-inking, cleaning and maintenance products are gelled, prior to usage or during the course of the de-inking operation, using an ad hoc concentrated solution that contains at least one of the substances that makes up these gels. Once mixed in right proportions with another constituent/s such as a diluent, detergent or water, this substance can provoke a gelling and emulsifying chemical reaction.

4. According to claim 2, this procedure is characterized by the fact that the aforesaid de-inking, cleaning and maintenance gelled products are formulated in such a way to allow, once mixed with the residues such as printing inks or glazes, their evacuation through rinsing with water or with water mixed with agents that strengthen its detergent properties.

5. According to claim 2, that is characterized by the fact the aforesaid de-inking, cleaning and maintenance products and the de-inking agents as well have for diluent basis all types and origins of substances and compositions such as distilled petroleum, light oils, esters of vegetable or synthetic origins, diluting oils and are a result of either chemical reactions, addition of detergent agents, thixotropents or others in the form of gelled or gelling from a liquid to a solid state, or in the form of milks like diluent detergent emulsions, or in the form of de-inking diluents or solvents that are liquid and oily, thus eliminating the excess of dryness and adhesion of the ink residues.

6. According to claim 2, that is characterized by the fact that the de-inking agents that come out in the form of oily liquid diluents or solvents are used in combination with the cleaning by scraping devices 19 and do not require for their de-inking function to be, prior or during usage, mixed or emulsified to agents such as water. In addition they do not emit as it is the case with de-inking, cleaning and maintenance products volatile organic components and they comply with the changeable International Directive and Norms that govern this kind of substances or preparations.

7. According to claim 2, that is characterized by the fact that the gelified products contain de-inking agents such as diluents that when mixed with detergent agents provoke by physico-chemical, their gelling with a consistency and state that change depending upon their composition and among other things can be used with the soft scrapers 15 and the light oils as well by using the distribution ramps 32 subservient to all known means that allow a sequential or continuous distribution allowing a dosage with the appropriate proportions of the ones with respect to the others the various constituents of these gels and light oils.

8. De-inking, cleaning and maintenance device for the implementation of the procedure upon claim 1 is characterized by the fact that the metallic hard scrapers of the cleaning by scraping devices (19) have a scraping edge that is hard, stiff and flexible with a sharp angle, that is able to scrape, in order to recover it, a printing oily ink of offset type that is typographical and that their active scraping parts are made of materials such as metal allowing a direct scraping like in the case of hard scrapers 22, and this without any previous dilution, approximately eighty per cent of the oily ink residues and that they are made with hard materials such as plastic materials like polyethane, polyester, polycarbonate, polypropylene, vinyl polychloride.

9. De-inking, cleaning and maintenance device for the implementation of the procedure according to claim 8, is characterized by the fact that the hard scrapers (22) made of materials such as hard plastic have a toughness between eighty five and ninety shores D, of which stiff and flexible bending depends upon the nature of the material combined with a form effect collated to their scraping edge (40) and profile section (41) of their active zone of scraping.

10. De-inking, cleaning and maintenance device for the implementationtion of the procedure according to claim 9 is characterized by the fact that the grinder of sharp angle scraping edge (40) of the hard scrapers (22) and the semi-hard scrapers (24) work along with the cleaning by scraping device (19) by using their groove (43) in which are running the moving rollers (44) of the tools carrier (45) over which is installed the severing tool (46) working by displacement their sharp angle scraping edge (40).

11. De-inking, cleaning and maintenance device for the implementation of the procedure according to claim 1 that is characterized by the fact that the semi-hard scrapers (24) of the cleaning by scraping device (19) have a strong general mechanical posture and stiffness and their scraping edges are made with stiff lightly bendable materials like all types of elastomeric materials such as polyethane, polyester that have a toughness that ranges between approximately eighty shores D and that these scraping edges with strong stiffness, are lightly bendable and a variable sharp angle that ranges between approximately forty five to eighty degrees depending on the toughness, positioning and variable angle of these scrapers, of a minimum of fifteen degree with respect to the axle of the ink tables (4) or (21) and that in function of this angle and their toughness, these scrapers are stiffed up to very close to their sharp angle scraping edge, at approximately one to three millimeters, with some kind of a metallic frame that is made of materials with various toughness.

12. Device according to claims 8 to 11 that is characterized by the fact that the hard scrapers (20) and (22) or semi-hard scrapers (24) of the cleaning by scraping device (19) have a weighed and pre-adjusted pressure of usage by changing the shape, the thickness and the geometry of these scrapers and in addition they have their higher surfaces of the residues located on the same plan of these faces, and their sharp angle scraping edges are finely smoothed.

13. De-inking, cleaning and maintenance device for the implementation of the procedure according to claim 8 is characterized by the fact that the ink tables (21) have a surface that is finely rectified with good oil properties in addition to a mechanical resistance and a friction coefficient that is adapted to the usage of hard scrapers (20) with which they cooperate.

14. De-inking, cleaning and maintenance device for the implementation of the procedure according to claim 1characterized by the fact that the automation and rationalization of the distribution of the various liquid de-inking agents and de-inking, cleaning and maintenance products gelled from liquid to solid and maintained by distribution ramps (32) that are automatic, placed side by side with connecting screws (36) and of which the upper part of the distribution ducts (33) is fed through the upper part of the feeding conduct (34), of which the conduct of the distribution ducts (33) contain a flow out slower up that is micro-porous, in such a way to avoid, off service, any parasitic flow out of which the connector (37) is fed with all kinds of manual controlled feeding or subservient to known control means such as electronic or electromechanical or with manual distributors bottles that have well known dosage tools.

15. Device according to claim 14 that is characterized by the fact that the distribution ramps 32 are located and connected to the printing press 1 with square supports 62 equipped with a anti-skidding roller 63 that is leaning on each side of the printing press 1 frame 64 with blocking screws 67 operating on the threaded rod.

16. Device according to claims 8 and 9 characterized by the fact that the hard scrapers (20) and (22) and the semi-hard scrapers (24) are covered with a disposable casing (29) equipped or no with bellows (30) that have a V shape with gluing zones (31) containing a permanent re-positional adhesive or any other material such as a grease allowing them to stay in place and remove easily after usage and that the disposable casings (29) are positioned on top and at a distance close to two millimeters from the thinned out active scraping part of the semi-hard scrapers (24) or hard scrapers (20) and (22).

17. De-inking, cleaning and maintenance device for the implementation of the procedure according to claim 15 that is characterized by the fact that mobile supports (53) are used for de-inking, cleaning and maintenance of a set of printing presses and printing materials are used and equipped with storing containers (54) and (55) for the various de-inking, cleaning and maintenance “gelled” or “gelling” products as well as all kinds of products necessary for the various de-inking cleaning and maintenance functions of the printing material from which the dosing pumps (56) and (57) drive forward these products through tubes (58) and (59) that are equipped with fast joins (60) easily connecting to the automatic distribution ramps (32) in order to distribute them in a pre-established fashion with the computerized control desk (61).

18. De-inking, cleaning and maintenance device for the implementation of the procedure according to claim 1 characterized by the fact that the cleaning by scraping devices (19) replace the de-inking devices (13) or integrate into any type of place on all kinds of existing printing presses either paper sheet by paper sheet or continuous tape or directly fit upon the producing of printing presses.

19. De-inking, cleaning and maintenance device for the implementation of the procedure according to the claim and comes with an ink table and a hard scraper with a sharp angle scraping edge and made with hard materials such as metal or plastic, characterized by the fact that the sharp angle of the scraping edge was treated and polished in order to obtain a surface state and have as well a scraping profile that allows to obtain, by form effect, a weighed pressure all along the scraper and furthermore characterized by the fact that the ink table has a non-metallic hard surface that is finely rectified and smoothed.
